(19) United States
(12) Patent Application Publication
(10) Pub. No.: US 2015/0356108 A1
(43) Pub. Date: Dec. 10, 2015

(54) STORAGE SYSTEM AND STORAGE SYSTEM CONTROL METHOD

(71) Applicant: HITACHI, LTD., Chiyoda-ku, Tokyo (JP)

(72) Inventors: Hitoshi KAMEI, Tokyo (JP); Masaaki IWASAKI, Tokyo (JP)

(73) Assignee: HITACHI, LTD., Tokyo (JP)

(21) Appl. No.: 14/760,568

(22) PCT Filed: May 21, 2013
(86) PCT No.: PCT/JP2013/064097

§ 371 Date: Jul. 13, 2015

(51) Int. Cl. G06F 17/30

(52) U.S. Cl. CPC G06F 17/30132; G06F 17/30106; G06F 17/30091; G06F 17/30233

(57) ABSTRACT

The present invention is provided to suppress input and output requests to a storage apparatus when a plurality of cloned files has been created based on one shared file. A storage system comprises a plurality of clone-use cache areas 304 corresponding to the cloned files, and a shared cache area 305 corresponding to a shared file. When a read request for any of the cloned files has been received, a prescribed clone-use cache area, from among the plurality of clone-use cache areas, that corresponds to the read-target cloned file is searched for the read-target data, and when determination is made that the read-target data does not exist in the prescribed clone-use cache area, the shared cache area 305 is searched for the read-target data.

### TECHNICAL FIELD

The present invention relates to a storage system and a method for controlling the storage system.

### BACKGROUND ART

Companies, universities and other such organizations have installed large numbers of physical computers (PCs), and as a result, are facing the problem of the increased costs of managing the physical PCs. Accordingly, in recent years, attention has been turning to a technique called virtual desktop infrastructure (VDI) for reducing equipment management costs by using PC virtualization techniques to reduce the number of physical PCs.

In VDI, companies, universities and other such organizations convert from physical PCs provided to end users to virtual PCs that run on virtual servers. That is, VDI uses a virtualization program to create a plurality of virtual PCs on a physical computer, and provides these virtual PCs to end users in place of physical PCs. The number of physical PCs in operation can be reduced by running a large number of virtual PCs on a single virtualization server, thereby enabling management costs to be held down.

When implementing a virtual PC, time-consuming virtual PC setup tasks are needed. Specifically, it is necessary to create a virtual disk file (VMDK file) for the virtual PC, to install an operating system (OS) in the virtual PC, and, in addition, to provide a desktop environment for network setup and the like.

To reduce work time, a VMDK file for which the aforementioned setup tasks have been implemented is replicated. Replication time can be shortened by using a file cloning function to replicate the setup-completed VMDK file, with the result that the virtual PC implementation time can be shortened even further.

However, when a plurality of virtual PCs is operated all at once, bottlenecks occur in disk I/Os to the storage apparatus, causing virtual PC response performance to deteriorate.

Consequently, in the prior art, a shared cache used by a plurality of virtual PCs is used to alleviate the deterioration of response performance due to disk I/O bottlenecks (PTL 1). A shared cache is configured from hash values and cache data. A hash value is computed for each block of the VMDK file beforehand and these hash values are stored in the shared cache as a digest file.

Data that a certain virtual PC reads from a disk is stored in the shared cache together with the hash values. When another virtual PC reads the data, an attempt is made to acquire the data by searching the shared cache based on the data block hash values in the digest file. Since I/Os to and from the disk are not necessary when the data can be acquired from the shared cache, disk I/O bottlenecks can be held in check. The same data is included in a group of replicated VMDK files, and as such, the hash values match, making it possible to use the data in the shared cache.

### CITATION LIST

### Patent Literature

[PTL 1]

U.S. Pat. No. 7,809,8888

### SUMMARY OF INVENTION

### Technical Problem

In the prior art, a digest file for a VMDK file is created by reading the entire VMDK file and operating on the hash values. The problem, therefore, is that the VMDK file must be accessed frequently and hash value operations must be performed in order to create the digest file, resulting in a heavy processing load.

Since a digest file is created for each VMDK file, the total size of the digest files is large. Also, when there is no data in the shared cache, a disk I/O is generated for a read.

With the foregoing problems in view, an object of the present invention is to provide a storage system and a method for controlling the storage system that makes it possible to utilize the cache effectively while holding down input/output requests to the storage apparatus when a plurality of cloned files have been created.

### Solution to Problem

A storage system related to one aspect of the present invention includes a controller coupled to a storage apparatus, wherein the controller is configured to: provide a plurality of cloned files that reference a shared file stored in the storage apparatus to one or more virtual computers; store shared-file difference data generated by a data write to a cloned file in a storage area, from among the storage apparatus storage areas, that corresponds to the cloned file; comprise a plurality of clone-use cache areas associated with each cloned file and a shared cache area associated with a shared file; search, from among the plurality of clone-use cache areas, a prescribed clone-use cache area corresponding to the read-target cloned file for the read-target data when a read request for any of the cloned files is received; and search the shared cache area for the read-target data when a determination has been made that the read-target data does not exist in the prescribed clone-use cache area.

### BRIEF DESCRIPTION OF DRAWINGS

FIG. 1 is a drawing showing an entire information processing system that includes a storage system.

FIG. 2 is a drawing showing the configuration of a virtualization server.

FIG. 3 is a drawing showing the configuration of a file server.

FIG. 4 is a drawing showing the configuration of a storage apparatus.

FIG. 5 is a schematic drawing showing the structures of a cloned file and a shared file, and a reference method.

FIG. 6 is a schematic drawing showing the relationship between the structure of a cloned file, cloned file difference data, and a shared file.

FIG. 7 is a drawing showing the configuration of a file cache.

FIG. 8 is a schematic drawing showing a reference order for a file cache.

FIG. 9 is a flowchart of a process for searching the file cache.

FIG. 10 is a flowchart of a file read process.

FIG. 11 is a flowchart of a file write process.

FIG. 12 is a drawing showing the configuration of a file server related to a second embodiment.

FIG. 13 is a schematic drawing showing a user interface for configuring a threshold for cloned file difference data.

FIG. 14 is a flowchart of a process for searching a file cache.

FIG. 15 is a schematic drawing showing a user interface for configuring the usability of shared cache by cloned files related to a third embodiment.

FIG. 16 is a flowchart showing a process for searching a file cache.

### DESCRIPTION OF EMBODIMENTS

The embodiments of the present invention will be described hereinbelow by referring to the attached drawings. However, it should be noted that the embodiments are merely examples for realizing the present invention, and do not limit the technical scope of the present invention. A plurality of features disclosed in the embodiments can be combined in various ways.

In the descriptions of the processing operations of the embodiments, a “computer program” may be described as the doer of the action (the subject). The computer program is executed by a microprocessor. Therefore, the processor may be interpreted as doer of the action.

In the embodiments, as will be described below, a plurality of cloned files replicated from a shared file can share a shared-file cache area as well as a cache area for cloned file use.

In the embodiments, cache data is shared by using the structure of a cloned file created using a file cloning function. A cloned file group comprises a group of one shared file and a plurality of cloned files. Data shared by the cloned files is stored in the shared file.

When the data of a shared file is read from a disk in response to a certain virtual PC accessing a cloned file, the data is stored in a shared file cache (shared cache area). When a different virtual PC reads the shared file data, the cache data stored in the shared file cache can be used. By operating in this manner, there is no need to create a digest file or to store a digest file in memory.

According to the embodiments, cloned files replicated using the file cloning function are able to share the cache data of a shared file, thereby making it possible to reduce the I/O load on the disks.

### Embodiment 1

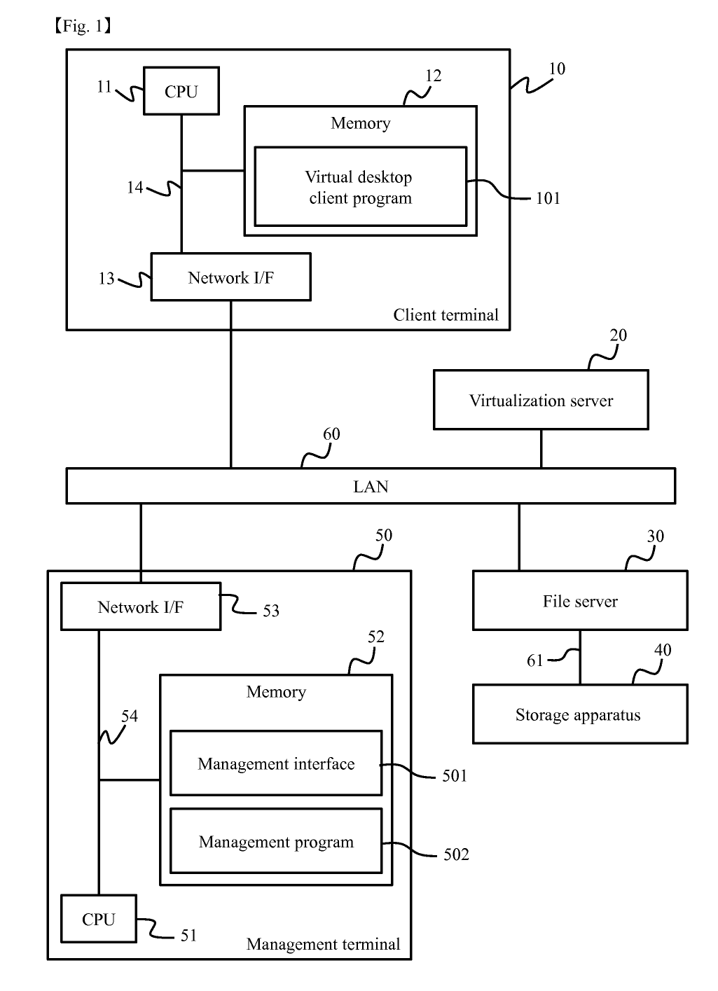

A first embodiment will be described using FIGS. 1 through 11. FIG. 1 shows the overall configuration of an information processing system that includes a storage system according to this embodiment. The information processing system, for example, comprises at least one client terminal 10, at least one virtualization server 20, at least one file server 30, at least one storage apparatus 40, and at least one management terminal 50.

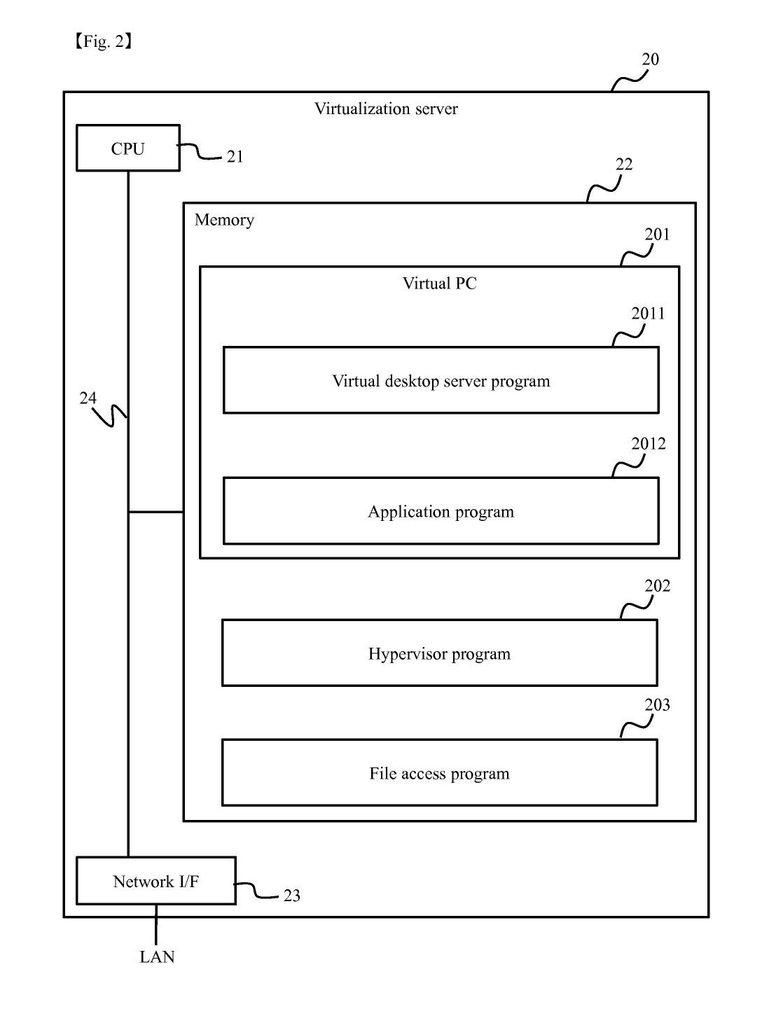

The client terminal 10 is a computer that an end user uses to make use of a virtual PC 201 (refer to FIG. 2). The client terminal 10, for example, comprises a CPU 11, a memory 12, and a network interface 13, and these components are connected to one another via an internal bus 14.

A virtual desktop client program 101 for connecting to the virtual PC 201 running on the virtualization server 20 is stored in the memory 12. The CPU 11 executes the program 101 stored in the memory 12. In the descriptions that follow, unless otherwise stated, a program is executed by the CPU.

The virtualization server 20 is a computer that runs the virtual PC 201. The internal processing of the virtualization server 20 will be described below.

A local area network (LAN) 60 is a bus for coupling the client terminal 10, the virtualization server 20, the management terminal 50, and the file server 30. The LAN 60 may be configured using an Ethernet (registered trademark) or a wireless LAN access point apparatus. This embodiment is not limited to a LAN 60 coupling mode.

The management terminal 50 is a computer used to manage the storage system, and is used by the storage system administrator. The management terminal 50, for example, comprises a CPU 51, a memory 52, and a network interface 53, and these components are connected to one another via an internal bus 54. A management interface 501 and a management program 502 are stored in the memory 52.

The management interface 501 is a program for providing the administrator with a graphical user interface (GUI)-based setup screen. The management program 502 is for configuring a value by sending a setting value inputted via the management interface 501 to the file server 30.

The management terminal 50 comprises an information input device for inputting information to the management terminal 50, and an information output device for outputting information from the management terminal 50 (neither is shown in the drawing). The information input device, for example, may be a keyboard, a pointing device, a visual line detector, a motion detector, an audio input device, or the like. The information output device, for example, may be a display, a voice synthesis device, a printer, or the like.

The file server 30 is a computer for providing a file sharing service to the virtualization server 20. The internal processing of the file server 30 will be described below.

The storage apparatus 40 is a disk apparatus coupled to the file server 30, for example, via a network 61 such as a storage area network (SAN). The storage apparatus 40 has a disk area utilized by the file server 30. The internal operations of the storage apparatus 40 will be described below.

FIG. 2 shows the configuration of the virtualization server 20. The virtualization server 20, together with the file server 30, comprises one example of a “controller”. In addition, the virtualization server 20 corresponds to an example of a “virtualization management server”. The virtualization server 20, for example, comprises a CPU 21, a memory 22, and a network interface 23, and these components are connected to one another via a bus 24.

For example, the virtual PC 201, a hypervisor program 202, and a file access program 203 are stored in the memory 22. The virtual PC 201 is a virtual computer created by the hypervisor program 202. The virtual PC 201 has the same functions as a physical computer. A virtual desktop server program 2011 and an application program 2012 run on the virtual PC 201.

A disk used by the virtual PC 201 is a file (VMDK file) stored in the storage apparatus 40, and is allocated by the hypervisor program 202. The virtual desktop server program 2011 is for providing a virtual PC 201 desktop environment on the client terminal 10. Upon receiving an access request from the virtual desktop client program 101 on the client terminal 10, the virtual desktop server program 2011 provides the client terminal 10 with a desktop environment by way of the network 60.

The application program 2012, for example, is a program such as office software for preparing and editing documents and/or diagrams or tables, a web browser for perusing a web server, or electronic mail management software for sending and receiving e-mails.

The hypervisor program 202 is a computer program for creating the virtual PC 201. The hypervisor program 202 manages the starting and stopping of the virtual PC 201, and manages the allocation of CPU resources, disk resources, and memory resources.

The file access program 203 is for utilizing a file sharing service provided by the file server 30. The virtualization server 20 is configured to access the file server 30 and to access a VMDK file that is stored in the storage apparatus 40 coupled to the file server 30 through the file access program 203.

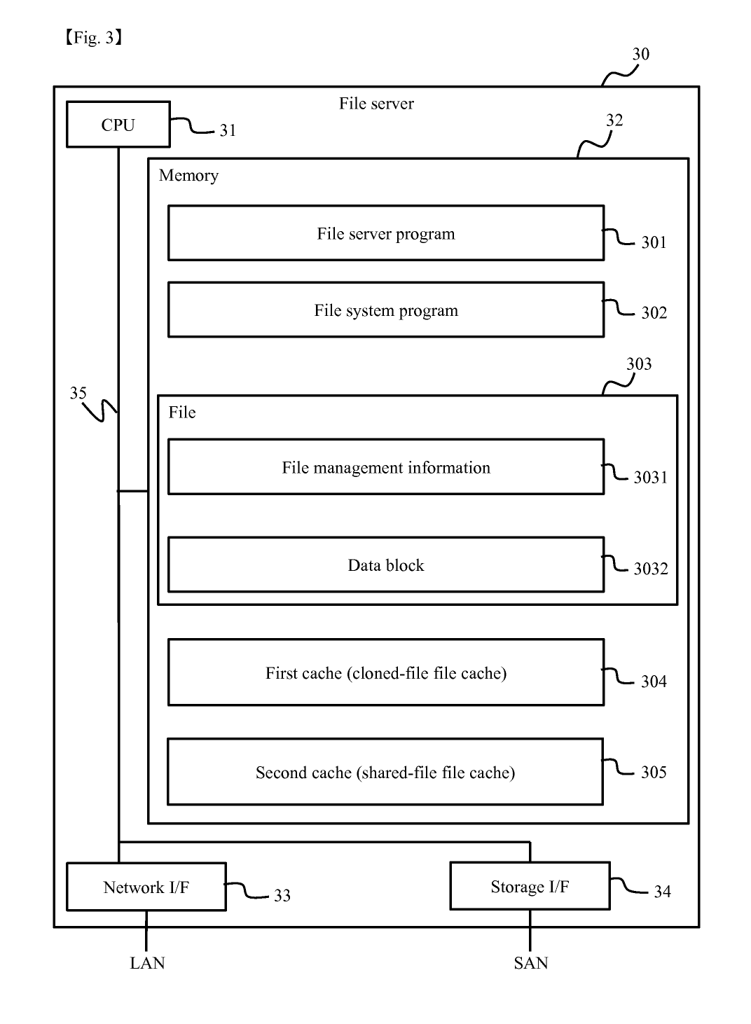

FIG. 3 shows the configuration of the file server 30. The file server 30, together with the virtualization server 20, comprises an example of a “controller”. The file server 30 corresponds to an example of a “file management controller”. In a case where the virtualization server 20 is called either a first controller or a second controller, the file server 30 can be called either the second controller or the first controller.

The file server 30, for example, comprises a CPU 31, a memory 32, a network interface 33, and a storage interface 34 that makes use of a serial attached SCSI (SAS), and these components are connected together via a bus 35.

For example, a file server program 301, a file system program 302, a file 303 read from a disk 45, a first cache 304, and a second cache 305 are stored in the memory 32.

The file server program 301 is for receiving a file access request issued from the file access program 203 of the virtualization server 20, and performing a read or write process on a file. The file system program 302 is for managing data stored in a disk 45 as a file, and performing cache control for read data and write data.

The file 303 is configured from file management information 3031 and a data block 3032. The file management information 3031, specifically, is an mode that has a proprietary user ID and data block 3032 storage-destination information. The data block 3032, for example, is the contents of a file, such as the contents of an office document. FIG. 3 shows a state in which the data of a file stored on a disk 45 has been read to memory 32.

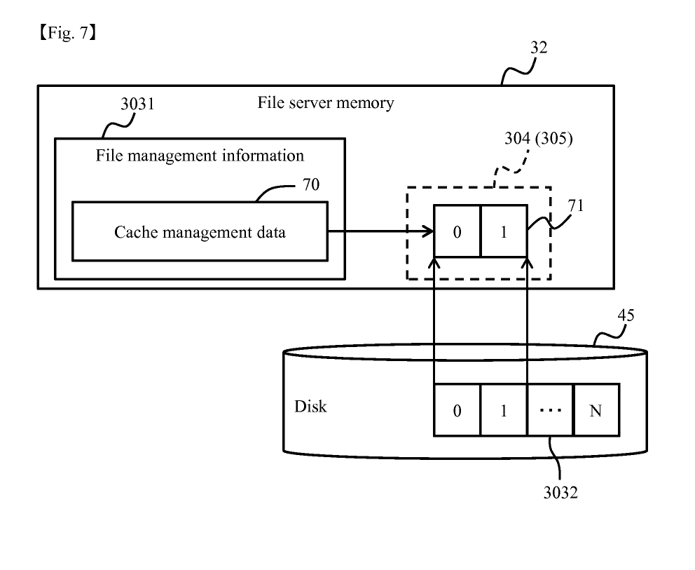

The first cache area 304 is a memory area for storing file cache data 71B (refer to FIG. 7) of a cloned file 303B, which will be described below. The second cache 305 is a memory area for storing the file cache data 71A (refer to FIG. 7) of a shared file 303A, which will be described below.

The first cache area 304 and the second cache area 305 are not configured in a clearly distinguishable manner in the memory 32 area. An aggregate of segments (storage units) for storing the cache data 71B of the cloned file 303B is recognized as the first cache area 304. Similarly, an aggregate of segments for storing the cache data 71A of the shared file 303A is recognized as the second cache area 305.

In the following description, file-cached data may be abbreviated as either cache data or a file cache. The first cache area 304 and the second cache area 305 may be abbreviated as the first cache 304 and the second cache 305.

The file server 30 is communicably coupled to the storage apparatus 40 from the storage interface 34 via a fibre channel (FC) or other such network 61.

The file server 30 can manage a plurality of groups comprising a plurality of cloned files 303B referencing a shared file 303A. That is, a cloned file group 303B that references a certain shared file 303A and another cloned file group 303B that references another shared file 303A can be managed by a single file server 30.

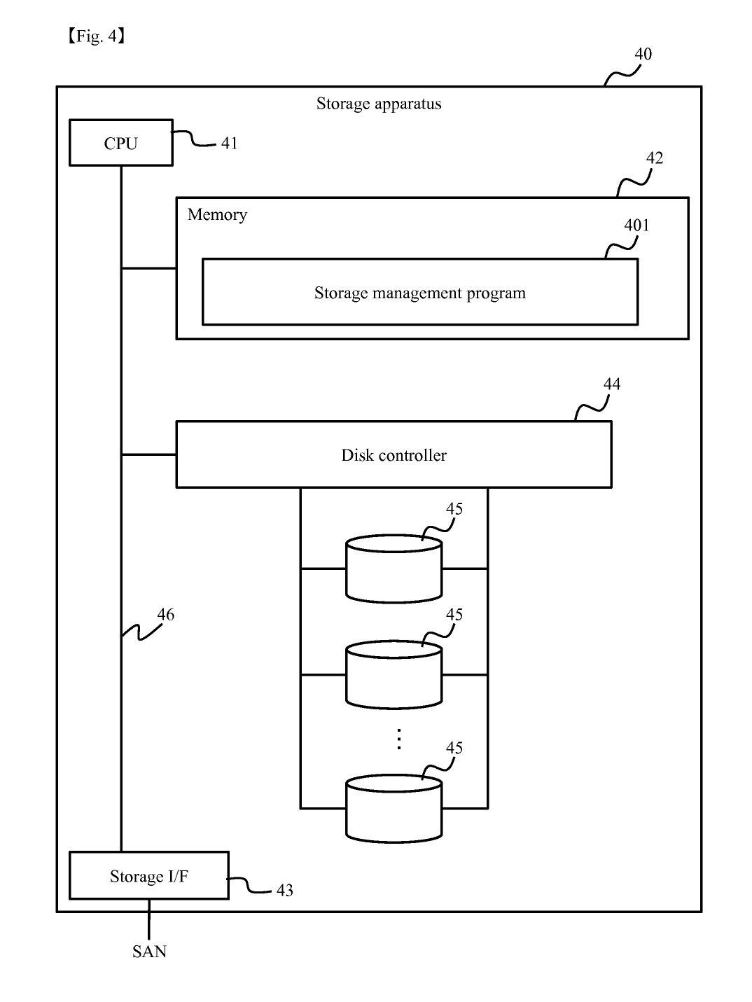

FIG. 4 shows the configuration of the storage apparatus 40. The storage apparatus 40, for example, comprises a CPU 41, a memory 42, a storage interface 43, and a disk controller 44, and these components are connected via a bus 46. The disk controller 44 is coupled to at least one or more disks 45 via redundant communication paths.

The memory 42, for example, stores a storage management program 401 for managing storage. The disk controller 44 has a redundant array of inexpensive disks (RAID) function, and improves the fault tolerance of the disks 45 by making a plurality of disks 45 redundant.

For example, a variety of storage devices capable of reading and writing data, such as a hard disk device, a semiconductor memory device, an optical disk device, and a magneto-optical disk device, can be used as the disk 45, which is an example of a “storage device”.

For example, a fibre channel (FC) disk, a small computer system interface (SCSI) disk, a SATA disk, an AT attachment (ATA) disk, and a serial attached SCSI (SAS) disk can be used. Also, for example, a variety of storage devices, such as a flash memory, a ferroelectric random access memory (FeRAM), a magnetoresistive random access memory (MRAM), an ovonic unified memory, and a RRAM (registered trademark) can be used. In addition, for example, the configuration may also be such that different types of storage devices like a flash memory and a hard disk device are intermixed inside the storage apparatus 40.

The storage management program 401 is for managing the RAID function of the disk controller 44. For example, the storage management program 401 configures a redundant configuration such as “6D+2P”. In this embodiment, the storage apparatus 40 may or may not comprise redundant functions. The storage apparatus 40 may comprise a function for storing the file 303 data block 3032, and is not limited as to type of storage device and control method.

Furthermore, data stored in the disk 45 is described as data for which de-duplication processing is performed, and, as a rule, duplicate data is not stored in the disk 45.

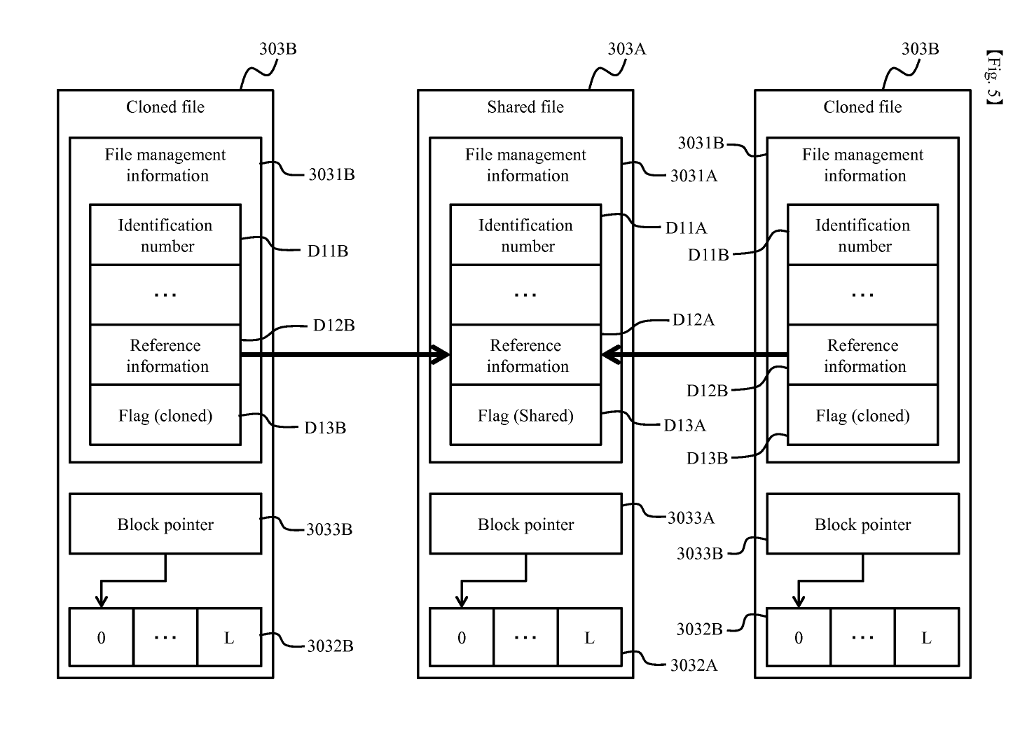

FIG. 5 shows the structure of a cloned file. This structure is created in the disk 45 and in the memory 32 of the file server 30. At file access, the structure shown in FIG. 5 is created in the memory 32 by a file being read from the disk 45.

When this structure is updated by a data write to the cloned file 303B, the updated structure is written back to the disk 45. Thus, this structure is controlled so that the structure in the disk 45 and the structure in the memory 32 are a match.

The cloned file 303B references the shared file 303A. The shared file 303A is for holding a data block 3032 that is shared among a plurality of cloned files 303B. In the example shown in FIG. 5, two cloned files 303B are referencing one shared file 303A. The cloned files 303B and the shared file 303A comprise file management information 3031, a block pointer 3033, and a data block 3032. For ease of understanding, “B” has been appended at the end of the reference sign in the configuration related to the cloned files 303B, and “A” has been appended at the end of the reference sign in the configuration related to the shared file 303A. When no particular distinction is made between the two configurations, a description will be provided without appending either “A” or “B” at the end of the reference sign.

The file management information 3031 is for holding the file type, the owner, and so forth, and, for example, includes an identification number D11 for identifying an individual file, reference information D12, and a flag D13. In addition, as will be described below, the file management information 3031 can include cache management data 70 (refer to FIG. 7). The utilization of these data will be described below.

The block pointer 3033 is data for referencing the data block 3032 stored in a disk 45 of the storage apparatus 40. The data block 3032A of the shared file 303A is shared by a plurality of cloned files 303B. The data block 3032A of the shared file 303A is not updated even when one of the cloned files 303B has been updated. The data block 3032B of the cloned files 303B is cloned file update data. That is, the data block 3032B of the cloned file 303B is the difference data with respect to the data block 3032A of the shared file.

The identification number D11 is used to uniquely identify an individual file. A different identification number D11 is allocated to each file. An identification number may also be called identification information, an identifier, and so forth.

Reference information D12B is data used by the cloned file 303B to reference the shared file 303A. An address of the reference-destination shared file 303A and the identification number D11A of this shared file 303A are stored in the reference information D12B. The reference information D12B is not limited thereto, and may be any information capable of identifying the shared file 303A. In this embodiment, the configuration of the reference information D12B is not limited.

Either one of a cloned file flag or a shared file flag is configured in the flag D13 to identify a cloned file 303B and a shared file 303A. When a file is a cloned file 303B, a cloned file flag is configured in the flag D13B. Alternatively, when a file is a shared file 303A, a shared file flag is configured in the flag D13A.

According to the structure of the cloned file shown in FIG. 5, a plurality of cloned files 303B is able to share data held in the shared file 303A. Also, when a new cloned file 303B references the shared file 303A is created, reference information D12B for the reference-destination shared file 303A is configured in the reference information D12B of the newly created cloned file 303B. Operating in this manner makes it possible to create a cloned file faster and with a smaller data size than a file that has been copied in its entirety.

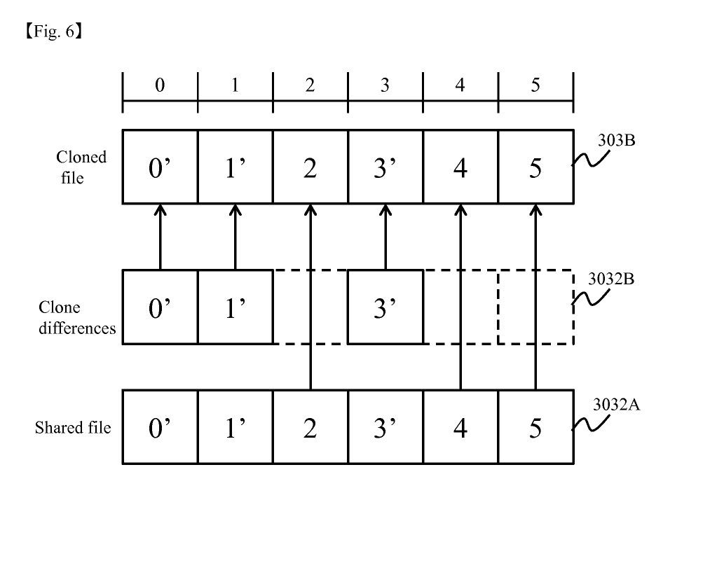

FIG. 6 shows the configuration of the cloned file 303B. The cloned file 303B is configured by superimposing the data block 3032B stored in the cloned file 303B onto the data block 3032A stored in the shared file 303A.

For example, when a cloned file 303B that has just been created and has yet to be updated receives a read request for this cloned file 303B, the data block 3032A of the shared file 303A is returned to the source of the read request. This is because the read-target cloned file 303B does not have difference data with respect to the reference-destination shared file 303A.

By contrast, when a cloned file 303B that has data written thereto and updated file content receives a read request, either of the data block 3032B of the cloned file 303B or the data block 3032A of the shared file 303A is returned to the read request source.

When the read-target data is difference data held in the cloned file 303B, the data block 3032B of the cloned file 303B is returned to the read request source. When the read-target data is the shared data held in the reference-destination shared file 303A, the data block 3032A of the shared file 303A is returned to the read request source.

In the example of FIG. 6, when the 0th block of the cloned file is read, the difference data “0′” of the cloned file 303B is read. When the 2nd block of the cloned file for which there is no difference data is read, the shared data “2” of the shared file 303A is read. Thus, the data block 3032B of the cloned file 303B is configured so as to mask the data block 3032A of the shared file 303A.

FIG. 7 shows the structure of the file cache. Cache management data 70 is added to the file management information 3031 read to the memory 32 of the file server 30. Since the data read to the memory 32 of the file server 30 from the data block 3032 of a disk 45 is managed as cache data 71, the cache management data 70 uses the memory address as a key to reference the cache data 71.

When the application program 2012 accesses a file, the cache data 71 is identified using the reference information of the cache management data 70 and the data is acquired. A portion of the data that has not been read to the memory 32 from the data block 3032 of the disk 45 does not appear in the cache data 71.

File cache data 71 is created for each file. That is, the file cache data 71B of the cloned file 303B and the file cache data 71A of the shared file 303A are managed individually. As described hereinabove, the file cache data 71B of the cloned file 303B is recognized as a first cache 304, and the file cache data 71A of the shared file 303A is recognized as a second cache 305.

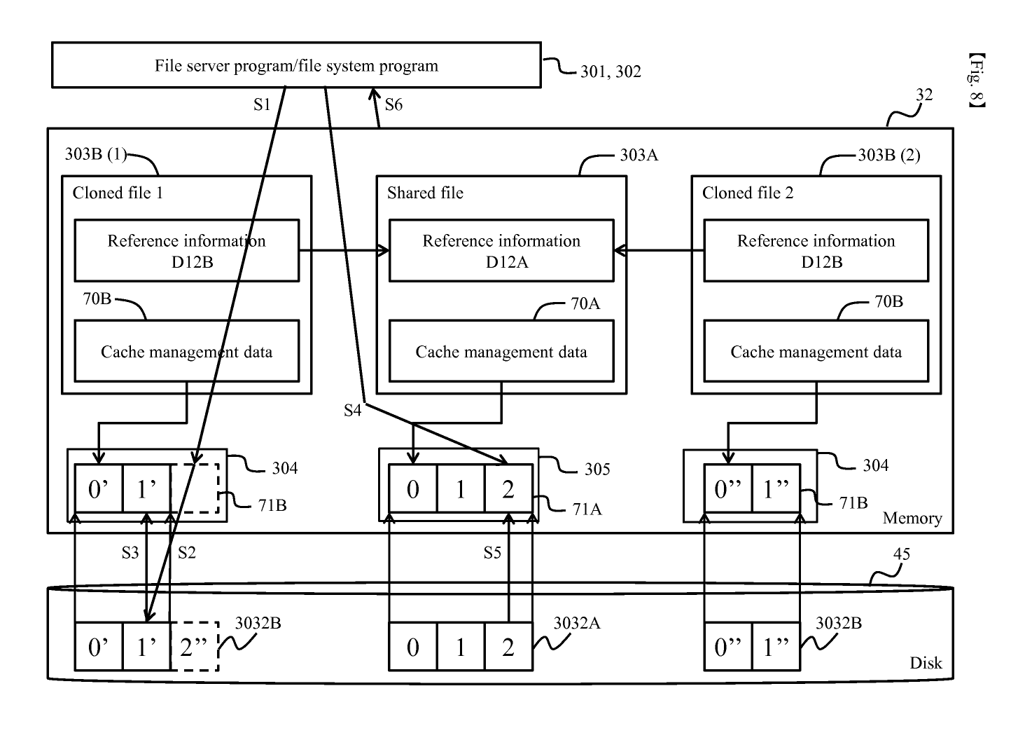

FIG. 8 is a drawing showing an overview of an operation in which the file system program 302 searches the file cache.

The memory address of the shared file 303A that has been read to the memory 32 of the file server 30 is configured in the reference information D12B of the file management information 3031B of the cloned file 303B read to the memory 32. As described hereinabove, any kind of value may be used in the reference information D12B as long as the value enables the file management information 3031A of the shared file 303A to be identified.

Management information for the cache data 71B of the data block 3032B of the cloned file 303B (the data of the first cache 304) is stored in the cache management data 70B of the cloned file 303B. Management information for the cache data 71A of the data block 3032A of the shared file 303A (the data of the second cache 305) is stored in the cache management data 70A of the shared file 303A.

An overview of the file cache search operation by the file system program 302 will be described. The file server program 301, upon receiving an access request for a cloned file 303B from the file access program 203 of the virtualization server 20, is configured to issue a file access request to the file system program 302.

The file system program 302 is configured to check the cache data 71B of the first cache 304 for the access-destination cloned file 303B. When the access-target data is in the cache data 71B of the first cache 304, the file system program 302 is configured to return this data to the file server program 301 (S1).

When the access-target data is not in the cache data 71B, the file system program 302 is configured to check whether the access-target data is in the disk 45 (S2). A case where the access-target data is stored in the disk 45 without being in the cache data 71B, for example, is one in which the access-target data is being read for the first time. When the access-target data (the data “1′” block here) resides in the disk 45, the file system program 302 reads the data to the memory 32, and holds the data as the first cache 304 (S3).

When the access-target data (the data “2′” block here) does not reside in the cloned file 303B of the disk 45, the file system program 302 searches the second cache 305 having the cache data 71A of the shared file 303A (S4).

When the access-target data is in the second cache 305, the file system program 302 returns the data to the file server program 301. When the access-target data (the data “2” block here) resides in the shared file 303A inside the disk 45 without being in the second cache 305, the file system program 302 is configured to read the data to the memory 32, and to hold the data as the cache data 71A of the second cache 305 (S5).

When the access-target data is not in the shared file 303A of the disk 45 either, the file system program 302 returns zero-padding data, which is padded with Os, to the file server program 301 (S6).

In accordance with the file system program 302 operating as described hereinabove, when the cloned file 303B (1) of FIG. 8 is read, the second cache 305 is configured in the shared file 303A when the data block 3032 does not reside in the cloned file 303B (1).

Therefore, subsequent thereto, the cache data 71A of the second cache 305 can be used when the cloned file 303B (2) is read. Thus, in this embodiment, the cache data 71A of the data block 3032A of the shared file 303A can be shared with a plurality of cloned files 303B. As a result of this, the data block 3032A of the shared file 303A may be read from the disk 45 only one time and managed as the cache data 71A of the second cache 305. As a result, for example, when the same OS is running on a plurality of virtual PCs 201, a plurality of cloned files 303B can share a relatively large amount of the cache data 71A of one shared file 303A, thereby enhancing the sharing effect and making it possible to reduce the number of I/Os issued to the disk 45.

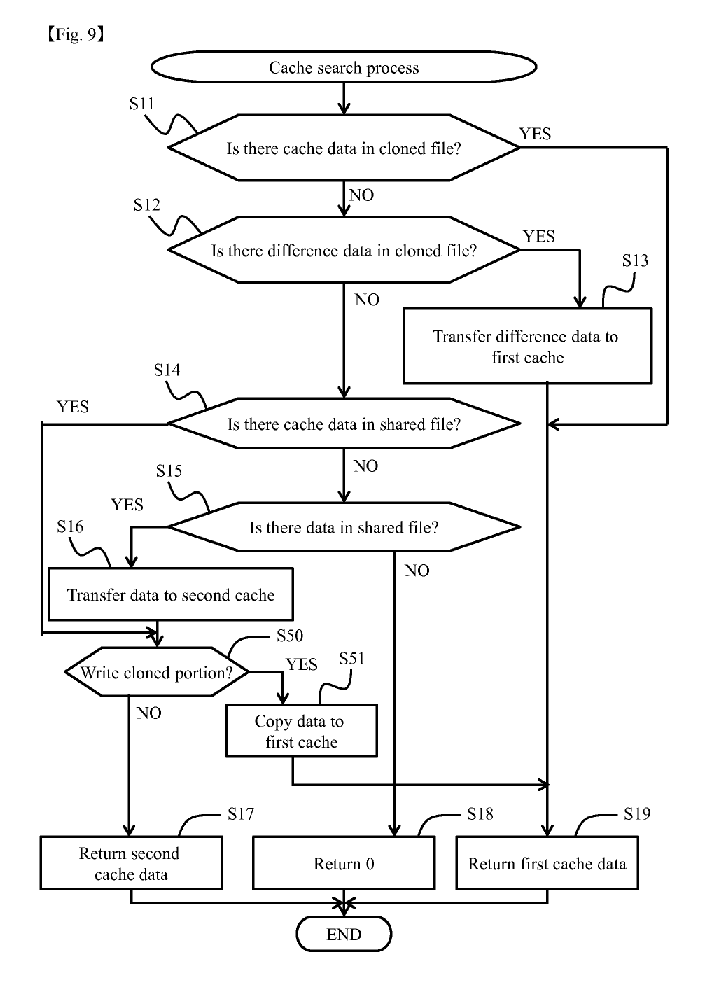

FIG. 9 is a flowchart of a process in which the file system program 302 searches the file cache. The file system program 302, upon receiving a file access request, is configured to search either the first cache 304 of the cloned file 303B or the second cache 305 of the shared file 303A for the target data. The file system program 302 is configured to initially check whether or not cache data 71B has been configured in the first cache 304 of the cloned file 303B (S11).

Upon having determined that the cache data 71B is configured in the first cache 304 (S11: YES), the file system program 302 is configured to return this cache data 71B to the invocation source and to end the processing (S19).

Alternatively, upon having determined that the cache data 71B has not been configured in the first cache 304 (S11: NO), the file system program 302 is configured to check whether or not a data block 3032B of the cloned file 303B exists (S12). The file system program 302, upon having determined that there is a data block 3032B for storing difference data (S12: YES), is configured to read the data block 3032B to the cache data 71B (S13). The file system program 302 is configured to regard the read data as cached data belonging to the first cache 304, to return this data to the invocation source, and to end the processing (S19).

The file system program 302, upon having determined that a data block 3032 does not exist in the cloned file 303B (S12: NO), is configured to check whether there is cache data 71A in the second cache 305 of the shared file 303A (S14). Upon having determined that cache data 71A exists (S14: YES), the file system program 302 is configured to carry out the processing of Step 20 and beyond.

Alternatively, upon having determined that cache data 71A does not exist in the second cache 305 (S14: NO), the file system program 302 is configured to check whether or not there is a data block 3032A in the shared file 303A (S15). The file system program 302, upon having determined that there is a data block 3032A in the shared file 303A (S15: YES), is configured to read the data and to configure the data in the second cache 305 (S16). Then, the file system program 302 is configured to determine whether or not the cache search process is a partial write of a cloned file (S50). When the cache search process is a partial write (S50: YES), the file system program 302 is configured to copy the data in the second cache 305 to the first cache 304 (S51), and to return the first cache data to the invocation source (S19). Alternatively, when the cache search process is not a partial write (S50: NO), the file system program 302 is configured to return the second cache 305 data to the invocation source (S17). The file system program 302, upon having determined that a data block 3032A does not exist in the shared file 303A (S15: NO), is configured to return data padded with Os to the invocation source (S18).

When the file system program 302 operates as described hereinabove, the data block 3032B of the cloned file 303B is configured in the first cache 304, and the data block 3032A of the shared file 303A is configured in the second cache 305. As a result, a plurality of cloned files 303B is able to share the cache data 71A of the shared file 303A.

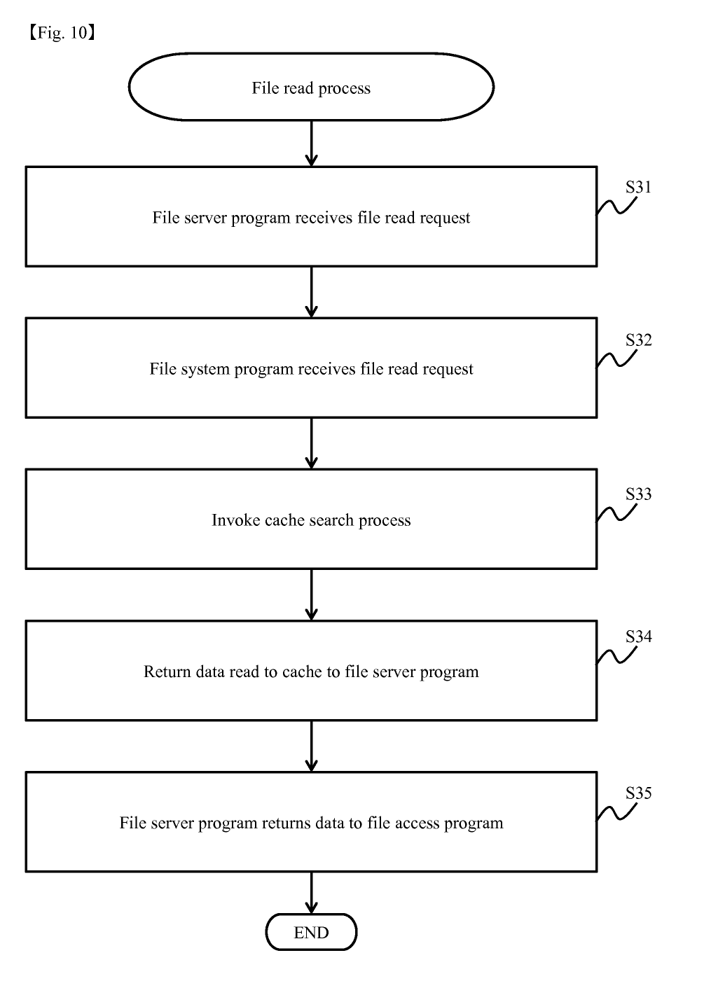

FIG. 10 shows a flowchart of a process in which the file system program 302 of the file server 30 reads a file.

The end user uses the virtual desktop client program 101 of the client terminal 10 to connect to the virtual desktop server program 2011 of the virtualization server 20. The virtual desktop server program 2011 is configured to run the application program 2012. When the application program 2012 reads a data block 3032 of a VMDK file created as the cloned file 303B, the application program 2012 is configured to invoke the file access program 203 through the hypervisor program 202.

The invoked file access program 203 is configured to send a file read request to the file server program 301 of the file server 30. The file server program 301 of the file server 30 is configured to receive the file read request (S31).

The file server program 301 is configured to send the file read request to the file system program 302, and the file system program 302 is configured to receive and process this file read request (S32).

The file system program 302 is configured to invoke the cache search process described in FIG. 9 (S33). In accordance with the cache search process, the data of the VMDK file data block 3032 is read and this data is returned to the file system program 302. The file system program 302 is configured to return the data block 3032 returned from the cache search process to the file server program 301 (S34).

The file server program 301 is configured to return the data to the file access program 203 (S35). The file access program 203 of the virtualization server 20 is configured to transfer the received data to the application program 2012 through the hypervisor program 202.

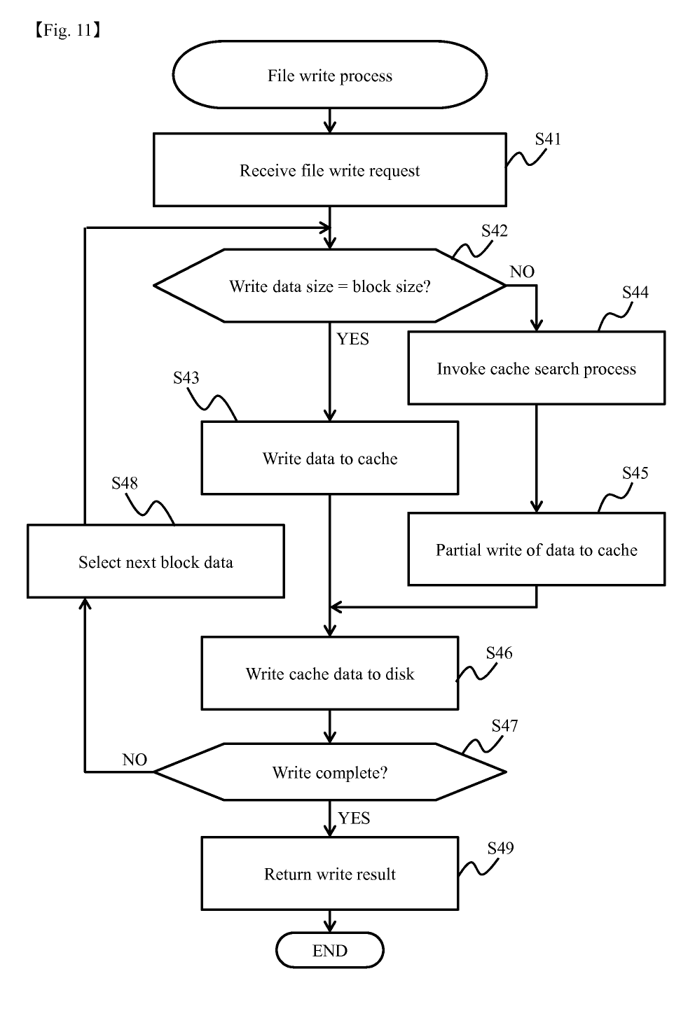

FIG. 11 is a flowchart of a file write process executed by the file system program 302 of the file server 30.

The end user uses the virtual desktop client program 101 of the client terminal 10 to connect to the virtual desktop server program 2011 of the virtualization server 20. The virtual desktop server program 2011 is configured to run the application program 2012. When the application program 2012 writes data to a data block 3032 of a VMDK file created as the cloned file 303B, the application program 2012 is configured to invoke the file access program 203 through the hypervisor program 202.

The invoked file access program 203 is configured to send a file write request and write-data to the file server program 301 of the file server 30. The file server program 301 is configured to receive the file write request, and to receive the write-data (S41). The file server program 301 is configured to send the file write request and the write-data to the file system program 302, and the file system program 302 is configured to receive the file write request (S41).

The file system program 302 is configured to check the size of the received write-data (S42). That is, the file system program 302 is configured to check whether the write-data size is equivalent to the block size, which is the data management size of the file system program 302 (S42).

The relationship between a block, which is the data management unit of the file system program 302, and a data rewrite of a file 303 will be described here. The file system program 302 is configured to manage data stored in a file 303 by segmenting the data into a sizes called a block.

The file system program 302 reads and writes data in block units. The size of a block, for example, is 4 KB. When the size of a file is 4 KB, the file constitutes one block. When the file system program 302 updates a block using less than 4 KB of data (partial update), the file system program 302 is configured to read data from the disk 45 to the memory 32, and to write the data, the contents of which have been rewritten by the updated data, to this block.

When there is 4 KB of data, the entire block is rewritten, thereby doing away with the need to read data from the disk 45 to the memory 32. When the size of the file is 5 KB, the file constitutes two blocks. When rewriting this file, the file system program 302 is configured to first rewrite the leading 4 KB (first block), and then to partially update the latter 1 KB (second block). The latter 3 KB of the second block's data is not used. Thus, the data stored in the file 303 is managed by being divided into blocks of a certain size, and is read and written in units of this size.

Return to FIG. 11. Upon having determined in Step S42 that the write-data size is the same size as the block size, the file system program 302 is configured to write the data to the first cache 304 (S43). The file system program 302 is configured to write to the disk 45 the data that was written to the first cache 304 (S46). The file system program 302 is configured to decide whether all the write-data has been processed (S47). The file system program 302, upon having determined that the write has not ended (S47: NO), is configured to select the next write-data block (S48) and to return to Step S42.

Upon having determined in Step S42 that the write-data size is smaller than the block size handled by the file system program 302 (S42: NO), the file system program 302 is configured to invoke the cache search process described in FIG. 9 in order to perform a partial update (S44). The file system program 302 is configured to perform a partial write of the data to the first cache 304 (S45), and to execute Step S46 and beyond.

The file system program 302, upon having determined in Step S47 that all of the received write-data has been written (S47: YES), is configured to return the write result to the file server program 301 (S49).

The file server program 301 is configured to return to the file access program 203 the write result received from the file system program 302. The file access program 203 of the virtualization server 20 is configured to transfer the write result to the application program 2012 through the hypervisor program 202.

As described hereinabove, in this embodiment, the data stored in the cloned file 303B (that is, the difference data that has been written to the cloned file 303B) is stored in the first cache 304 and managed for each file. Meanwhile, the data shared by the plurality of cloned files 303B created using the file cloning function is stored in the file cache 71 (second cache 305 data) of the shared file 303A and shared. Consequently, for example, when one shared file 303A is replicated to create a large number of cloned files 303B as in a case where a large number of virtual PCs 201 running the same OS has been created, according to this embodiment, the same data need not be cached for each clone, making it possible to use the cache efficiently.

Therefore, the cache data 71A that has been read in accordance with a file access to the cloned file 303B executed earlier can be used in the file access process for the next cloned file 303B. As a result, it is possible to reduce the number of I/Os to the disk 45, and to lessen the load on the file server 30 and the storage apparatus 40. Also, for a read, searching the second cache 305 when the target data does not exist in the first cache 304 makes it possible to compatibly read the shared data and the difference data, to include a cloned file, which was subjected to a new write and has difference data, without the need for a new computational load.

### Embodiment 2

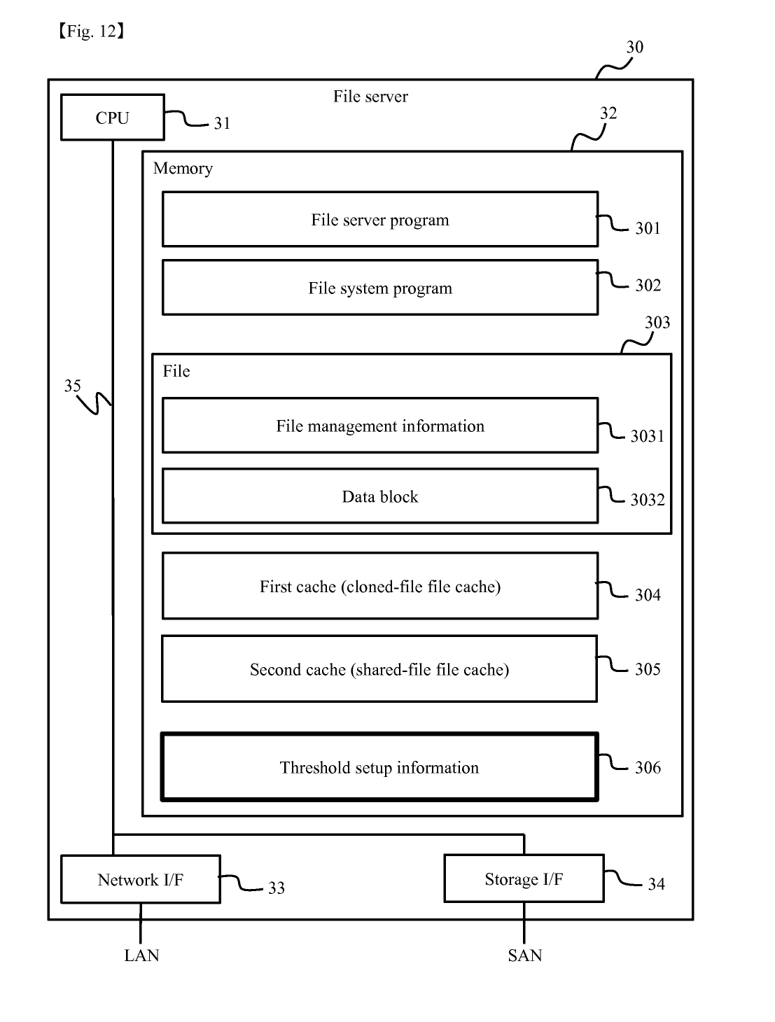

A second embodiment will be described using FIGS. 12 through 14. Each of the following embodiments, to include this embodiment, corresponds to a variation of the first embodiment, and as such, will be described by focusing on the differences with the first embodiment. In this embodiment, it is possible to control an option for sharing the second cache 305 on the basis of the capacity of the data block 3032B of the cloned file 303B (that is, the difference data capacity of the cloned file 303B) in order to improve the utilization efficiency of the file cache 71A (the second cache 305) of the shared file 303A.

For example, when the virtual PC 201 is operated for awhile, the difference data in the cloned file 303B increases due to file data created by the end user and OS update data. The configuration of this embodiment functions effectively since the difference data is unable to share the data of the second cache 305.

FIG. 12 shows the configuration of the file server 30 in this embodiment. The file server 30 of this embodiment comprises threshold setup information 306 for configuring a threshold for difference data in addition to the file server 30 components described in the first embodiment. The threshold setup information 306 is stored in the memory 32.

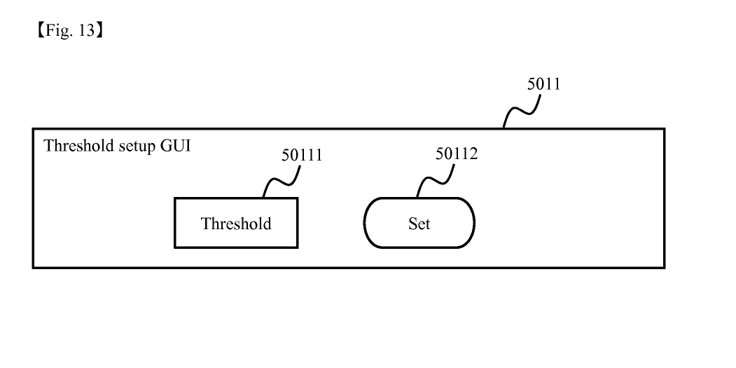

FIG. 13 is a drawing showing an example of a GUI 5011 provided by the management interface 501 of the management terminal 50 for configuring a threshold. The threshold setup GUI 5011 includes a threshold input part 50111 for inputting a threshold, and a set button 50112 for configuring the inputted threshold in the file server 30. The system administrator inputs a difference data capacity into the threshold input part 50111 and presses set 50112. In accordance with this, the difference threshold setup information 306 of the file server 30 is configured through the management program 502 of the management terminal 50. Also, the difference threshold setup information may be configured beforehand.

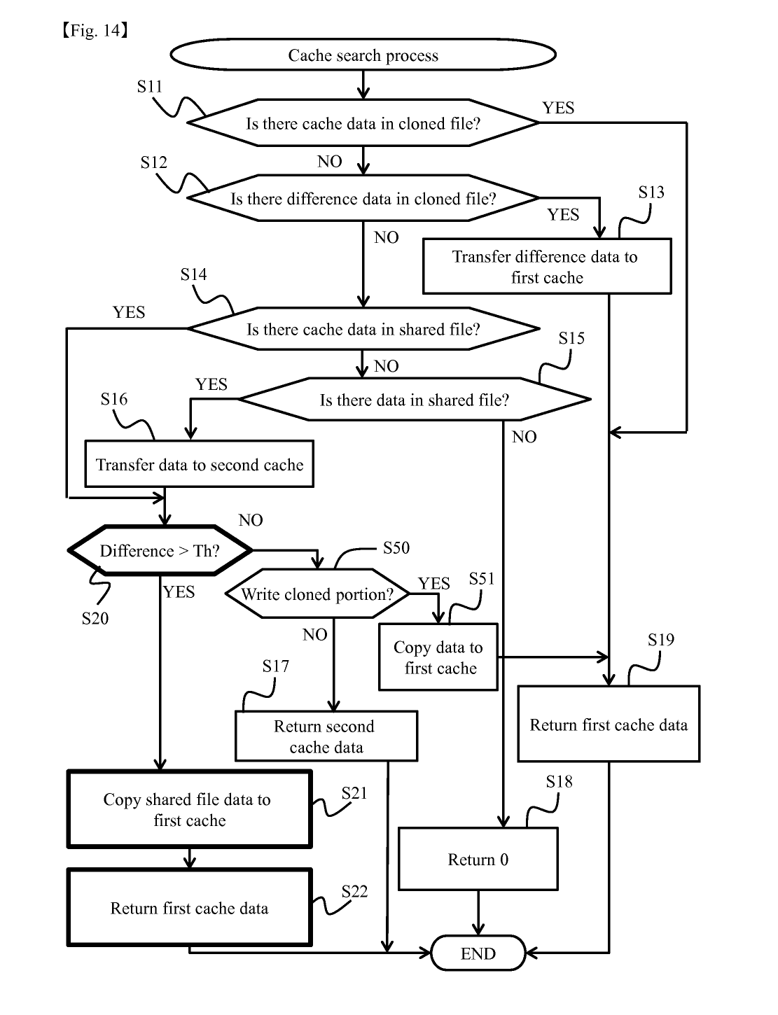

FIG. 14 is a flowchart showing a cache search process according to this embodiment. In this embodiment, when the capacity of the data block 3032B of the cloned file 303B is larger than the capacity configured in the threshold setup information 306, difference data is stored in the first cache 304. The cache search process of this embodiment comprises new steps S20 through S22 in addition to Steps S11 through S19 described in FIG. 9.

Upon either having determined in Step S14 that there is data in the second cache 305 or having read the data block 3032A of the shared file 303A to the second cache 305 in Step S16, the file system program 302 is configured to execute Step S20. In Step S20, the file system program 302 is configured to determine whether the size of the data block 3032B in the cloned file 303B (the difference data size) is larger than the threshold (Th) configured in the threshold setup information 306.

The file system program 302, upon having determined that the size of the data block 3032B in the cloned file 303B is equal to or less than the threshold Th (S20: NO), is configured to determine whether the cache search process is a cloned file partial write (S50). When the cache search process is a partial write (S50: YES), the file system program 302 is configured to copy the data in the second cache 305 to the first cache 304 (S51), and to return the first cache data to the invocation source (S19). Alternatively, when the cache search process is not a partial write (S50: NO), the file system program 302 is configured to return the second cache 305 of the shared file 303A to the source that invoked this process (S17).

Alternatively, upon having determined that size of the data block 3032B of the cloned file 303B is larger than the threshold Th (S20: YES), the file system program 302 is configured to copy the data of the second cache 305 to the first cache 304 of the cloned file 303B (S21). The file system program 302 is configured to return the first cache 304 data to the source that invoked the process (S22).

This embodiment, which is configured in this manner, exhibits the same operational effects as the first embodiment. In addition, in this embodiment, the cache search process described in FIG. 14 makes it possible to prevent a cloned file 303B with a difference data size that exceeds the threshold configured in the difference threshold setup information 306 from using the second cache 305. As a result, in the next and subsequent cache search processes, there is an increasing likelihood of YES being determined in Step S11 and of the file system program 302 being able to return the data in the first cache 304 of the cloned file 303B to the invocation source. As a result of this, in this embodiment, only a cloned file 303B with difference data equal to or less than a threshold is able to share the cache data 71A of the shared file 303A, thereby improving cache search efficiency. It thus becomes possible to reduce the processing load of the CPU and to enhance the access response performance of the cloned file.

### Embodiment 3

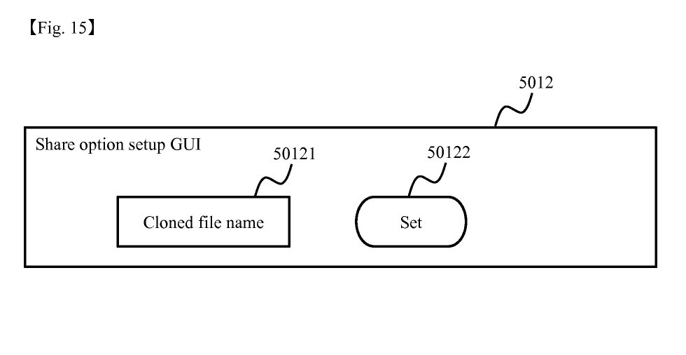

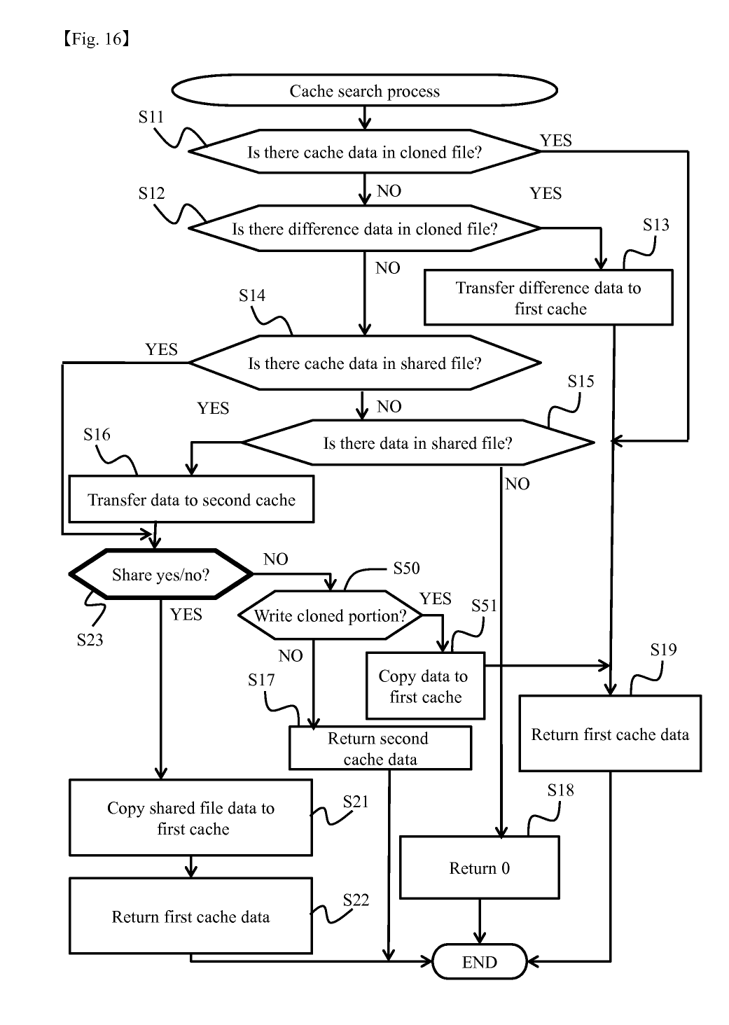

A third embodiment will be described using FIGS. 15 and 16. In this embodiment, setup information for specifying an option for sharing the file cache 71A is used to improve the utilization efficiency of the second cache 305. For example, the effect of sharing the file cache 71A can be low depending on the type of OS that is running on the virtual PC 201. This embodiment functions effectively in this case.

FIG. 15 shows an example of a GUI 5012 provided by the management interface 501 of the management terminal 50 for configuring a share option. The share option setup GUI 5012, for example, includes a cloned file name 50121 and a set button 50122. The system administrator inputs into the cloned file name 50121 the name of a cloned file to enable this function, and presses the set button 50122.

In accordance with this, a file cache sharing denial flag for denying the sharing of the file cache is configured in the flag D13A of the shared file 303A in the file server 30 through the management program 502 of the management terminal 50.

When the file cache sharing denial flag is configured in the shared file 303A, a cloned file 303B that references this shared file 303A does not share the second cache 305 of the shared file 303A.

FIG. 16 is a flowchart showing a cache search process. This process comprises Steps S11 through S19 described in FIG. 9 and Steps S21 and S22 described in FIG. 14, and, in addition, comprises a new Step S23 in place of Step S20 described in FIG. 14.

In this process, when the file cache sharing denial flag has been configured in the flag D13A of the shared file 303A, data read from the shared file 303A is stored in the first cache 304.

Upon either having determined in Step S14 that there is data in the second cache 305 or having read the data block 3032A of the shared file 303A to the second cache 305 in Step S16, the file system program 302 is configured to check whether the file cache sharing denial flag has been configured in the flag D13A of the shared file 303A (S23).

Upon having determined that the file cache sharing denial flag has not been configured (S23: NO), the file system program 302 is configured to determine whether the cache search process is a partial write of the cloned file (S50). When the cache search process is a partial write (S50: YES), the file system program 302 is configured to copy the data of the second cache 305 to the first cache 304 (S51), and to return the first cache data to the invocation source (S19). Alternatively, when the cache search process is not a partial write (S50: NO), the file system program 302 is configured to return the file cache 71A of the shared file 303A to the invocation source (S17). Alternatively, upon having determined that the file cache sharing denial flag has been configured (S23: YES), the file system program 302 is configured to copy the second cache 305 to the first cache 304 of the cloned file 303B (S21). Then, the file system program 302 is configured to return the data of the first cache 304 to the invocation source (S22).

This embodiment, which is configured in this manner, exhibits the same operational effects as the first embodiment. In addition, in this embodiment, when a cloned file 303B has been replicated using the file cloning function based on a shared file 303A for which the file cache sharing denial flag has been configured, this cloned file 303B does not share the file cache 71A of the shared file 303A. Accordingly, the user, either beforehand or while using the system, configures a file cache sharing denial flag so that the shared cache is not used for a file for which the merits of using the shared cache are low.

Therefore, when the cache-sharing effect is considered to be low, configuring the file cache sharing denial flag in the shared file 303A makes it possible to free up that much free space in the memory 32 of the file server 30. The memory 32 of the file server 30 can be utilized effectively by allocating this free memory to a group comprising another cloned file and shared file for which the cache-sharing effect is high. Also, not having to perform a shared cache search process makes it possible to improve the response performance of the system.

The present invention is not limited to the embodiments described hereinabove. A person skilled in the art can make various additions and changes without departing from the scope of the present invention. For example, the technical features of the present invention described hereinabove can be put into practice by combining these features as appropriate.

### REFERENCE SIGNS LIST

10 Client terminal
20 Virtual server
30 File server
40 Storage apparatus
50 Management terminal
70 Cache management data
71 Cache data
201 Virtual PC
301 File server program
302 File system program
303 File
303A Shared file
303B Cloned file
304 First cache area
305 Second cache area

1. A storage system including a controller coupled to a storage apparatus, wherein the controller is configured to:
provide to one or more virtual computers a plurality of cloned files that reference a shared file stored in the storage apparatus;
store shared-file difference data generated by a data write to the cloned files in a storage area, from among the storage apparatus storage areas, that corresponds to the relevant cloned file;
comprise a plurality of clone-use cache areas associated with the cloned files, and a shared cache area associated with the shared file; and
when a read request for any of the cloned files is received, search the shared cache area when determination is made that the read request target data does not exist in a prescribed clone-use cache area, of the plurality of clone-use cache areas, that corresponds to the read-target cloned file.

2. A storage system according to claim 1, wherein, upon receiving a read request for the read-target cloned file, the controller is configured to:
search the prescribed clone-use cache area for the read-target data;
search, from among the storage apparatus storage areas, a prescribed storage area corresponding to the read-target cloned file when determination is made that the read-target data does not exist in the prescribed clone-use cache area;
search the shared cache area when determination is made that the read-target data does not exist in the prescribed storage area; and
search, from among the storage apparatus storage areas, a shared storage area corresponding to the shared file when determination is made that the read-target data does not exist in the shared cache area.

3. A storage system according to claim 2, wherein, upon reading the read-target data from the prescribed storage area, the controller is configured to:
return the read-target data to the source of the read request after storing the read-target data in the prescribed clone-use cache area.

4. A storage system according to claim 3, wherein, upon reading the read-target data from the shared storage area, the controller is configured to:
return the read-target data to the source of the read request after storing the read-target data in the shared cache area.

5. A storage system according to any of claims 1, wherein, upon receiving a write request for any of the cloned files, the controller is configured to:
compare a size of a write-target data to a block size of the storage apparatus;
when determination is made that the size of the write-target data is smaller than the block size, read update-target data to be updated using the write-target data from any of the shared cache areas, a storage area corresponding to a write-target cloned file, a clone-use cache area corresponding to the write-target cloned file, and the shared storage area; and
overwrite the update-target data with the write-target data, and store the overwritten data in the storage area corresponding to the write-target cloned file.

6. A storage system according to any of claims 1, wherein, when determination is made that a used amount of the shared cache area exceeds a pre-configured prescribed value, the controller is configured to:
copy the read-target data stored in the shared cache area to the prescribed clone-use cache area.

7. A storage system according to any of claims 1, wherein
the controller is configured to be able to configure whether or not the cloned files share the shared cache area, and
when the configuration is formed in which the shared cache area is not shared, copy the read-target data stored in the shared cache area to the prescribed clone-use cache area.

8. A storage system according to any of claims 1, wherein
the controller includes a virtualization management controller for providing the plurality of cloned files to at least one virtual computer, and a file management controller for processing a read request and a write request for the cloned file, and wherein
the file management controller is configured to:
store the shared-file difference data generated by a data write to the cloned files in a storage area, of the storage areas of the storage apparatus, that corresponds to the relevant cloned file;
comprise a plurality of clone-use cache areas associated with the cloned files, and a shared cache area associated with the shared file;
when a read request for any of the cloned files is received, search, from among the plurality of clone-use cache areas, a prescribed clone-use cache area corresponding to a read-target cloned file, for the read-target data; and
search the shared cache area for the read-target data when determination is made that the read-target data does not exist in the prescribed clone-use cache area.

9. A method for controlling a storage system for managing a plurality of cloned files that reference a shared file,
with the storage system having a plurality of clone-use cache areas associated with the cloned files, and a shared cache area associated with the shared file,
the storage system control method comprising:
upon receiving a read request for any of the cloned files, searching, from among the plurality of clone-use cache areas, a prescribed clone-use cache area corresponding to the read-target cloned file, for read-target data; and
searching the shared cache area for the read-target data when determination is made that the read-target data does not exist in the prescribed clone-use cache area.

10. A storage system control method according to claim 9, wherein, when the storage system has received a read request for the read-target cloned file,
the method further comprising:
searching the prescribed clone-use cache area for the read-target data;
searching, from among the storage apparatus storage areas, a prescribed storage area corresponding to the read-target cloned file when determination is made that the read-target data does not exist in the prescribed clone-use cache area;
searching the shared cache area when determination is made that the read-target data does not exist in the prescribed storage area; and
searching, from among the storage areas of the storage apparatus, a shared storage area corresponding to the shared file when determination is made that the read-target data does not exist in the shared cache area.
